(19) United States
(12) Patent Application Publication
(10) Pub. No.: US 2003/0028478 A1
(43) Pub. Date: Feb. 6, 2003

(54) System and method for originating turbocharged ("Turbo TM") loans

(76) Inventors: James Michael Kinney, San Marcos, CA (US); Kenneth R. Kurtz, San Diego, CA (US)

Correspondence Address: James M. Kinney, Post Office Box 9438, Rancho Santa Fe, CA, 92067-4438, US

(21) Appl. No.: 10/210,565

(22) Filed: Jul. 31, 2002

Related U.S. Application Data
(60) Provisional application No. 60/309,354, filed on Aug. 1, 2001.

(51) Int. Cl. G06F 17/60

(52) U.S. Cl. 705/38

(57) ABSTRACT

A method and data processing apparatus for lending money, utilizing the benefits of an interest rate yield curve to provide additional benefits to borrowers without increasing borrower debt levels or cash flow costs. By bundling additional benefits with simplicity and convenience, the present invention delivers significant extra value to a borrower. In other words, the benefits to a borrower are “turbocharged.”

### CROSS REFERENCE TO RELATED APPLICATION

This application is entitled to the benefits of Provisional Patent Application No. 60/309,354, Filed 2001, August 1.

### FIELD OF INVENTION

This invention comprises a method and data processing apparatus for lending money utilizing the benefits of an interest rate yield curve.

### COPYRIGHT NOTICE

A portion of the disclosure herein contains material that is subject to copyright protection. The copyright owner has no objection to the facsimile reproduction by anyone of the patent document or patent disclosure as it appears in the Patent and Trademark Office patent files or records, but otherwise reserves all copyright rights whatsoever.

### BACKGROUND

Residential mortgage originations in the U.S. currently exceed $1.3 trillion annually (over $2 trillion in 2001) and are growing at a rate of 6-8% per year. Most of these loans are priced and sold in the secondary mortgage market at interest rates that are “marked up” over appropriate constant-maturity U.S. Treasury obligations (CMTs). For example, a 30-year residential, fixed-rate mortgage (the “standard” loan or mortgage used in the discussion and examples hereinafter) is commonly priced by mortgage lenders and sold in the secondary mortgage market at interest rates that include a variable mark-up to 10-year CMT rates. Shorter-maturity mortgages reflect variable mark-ups to the interest rates of correspondingly shorter-term CMTs. Thus, virtually all home loan interest rates are based on the interest rate yield curve (a line connecting CMT yields between 30 days and 30 years) then-prevailing when the loans were originated. Indicative of its importance, the interest rate yield curve is published every business day by The Wall Street Journal.

While the shape of the interest rate yield curve changes as interest rates change, it normally is “positive” or ascending, i.e., yields increase as maturities lengthen so that long-term rates exceed short-term rates. (For an a typical “negative” or inverted yield curve, the opposite is true.) Generally, the steeper the yield curve's positive slope, the lower short-term rates are relative to long-term rates. Originators of adjustable-rate mortgages (ARMs) utilize this slope to increase their loan volume by offering borrowers short-term ARMs with interest rates substantially lower than rates for standard loans. Portfolio lenders, such as savings banks, may keep the ARMs they originate in their portfolios, while predominately fixed-rate lenders, such as mortgage bankers, sell virtually all loans they originate in the secondary mortgage market.

Lower ARM rates translate into lower periodic payments (at least initially) than those for standard loans. However, unlike the borrower with a 30-year fixed-rate mortgage, an ARM borrower must accept the risk of higher interest rates (and potentially higher payments) after the initial short- or medium-term interest-adjustment date (which may occasion the possibility of “negative amortization” or owing more than the original loan balance).

Some ARM borrowers attempt to mitigate the tradeoff between lower payments and rate risk by financing with a fixed-period ARM. Such ARMs often have fixed interest rates for one to ten years, after which rates (and payments) change on a periodic basis. While most ARMs require full repayment of the original loan balance over 30 years, some recent fixed-period ARMs are interest-only (further lowering periodic payments) and do not reduce mortgage debt at all. Many fixed-rate lenders originate fixed-period ARMs and sell them in the secondary mortgage market.

Because a typical home loan is paid off in less than seven years, some financial planners and investment firms have recently begun to encourage wealthy borrowers to minimize periodic payments via fixed-period, interest-only ARMs and to invest the resultant periodic “savings” (relative to standard loans). Aside from the conflict of interest (and limited audience) inherent to such advice, these entities provide no structure linking mortgages with investment, insurance, or deposit vehicles for this purpose. Neither do they or other financial intermediaries provide any assurance that interest-only loans will be repaid at a rate equal to, or greater than, some pre-determined standard. Borrowers may do as they please with their periodic savings, including spending them on living expenses.

Positive yield curves enable mortgage lenders to offer mortgage borrowers two overriding financial benefits: lower short- and medium-term interest rates and lower periodic payments. Currently, however, mortgage lenders do not offer borrowers any additional benefits from a positive yield curve.

### SUMMARY OF THE PRESENT INVENTION

The present invention takes advantage of favorable cash flow differences arising from a normally positive interest rate yield curve to provide valuable benefits that are otherwise not available to borrowers. Benefits are provided in such a way as to reduce or eliminate uncertainty concerning equity accumulation. The present invention as presented herein utilizes the benefits of interest rate yield curves to fund installment investments in stocks, term life insurance, or mortgage amortization so as to offer mortgage borrowers additional borrower benefits. These concepts can be applied to other deposit, insurance and investment vehicles as well.

The present invention has three preferred and/or alternative mortgage loan embodiments. Each requires the same periodic payment as an alternative, standard loan used for comparison (earlier defined for purposes of example herein as a 30-year, fixed-rate, fixed-payment mortgage loan) and offers one of the following additional borrower benefits:

eTurbo™²: A stock portfolio is built with funds that would otherwise amortize the mortgage; a borrower might accumulate 52% greater equity (or more) over seven years. ² Notices of Allowance for service marks eturbo and iTurbo issued to (and pTurbo applied for by) Mileage Mortgage LLC, San Diego, Calif.

iTurbo™: Term life insurance covers the mortgage debt; a 30-year-old husband and wife might both be insured for the original amount of their mortgage.

pTurbo™: The mortgage amortizes more rapidly (borrowers benefit from a rate of debt repayment greater than the scheduled rate of repayment of the standard loan); a borrower might accumulate 35% greater equity (or more) over seven years.

Together, these loans (collectively referred to herein as “the present invention” or as “Turbo” loans) offer borrowers a range of new choices to match their financial and life circumstances. A young couple with children might prefer the extra protection of iTurbo, whereas another borrower might welcome the upside potential of eTurbo. For a more conservative borrower without the need for additional insurance protection, pTurbo delivers significant benefits by simply paying off the mortgage faster.

Most importantly, Turbo loans offer these additional borrower benefits without increasing the borrower's debt levels or cash flow costs (that is, borrowers incur no cash flow costs or debt levels in excess of those of a standard loan). They do so by taking advantage of the benefits of interest rate yield curves. A historically typical yield curve results in a 37.5 basis point difference between the interest rates on 7- and 30-year mortgages. This means that if the interest rate for a standard loan were 7%, a typical interest rate yield curve would result in a 6.625% interest rate for a loan whose interest rate adjusts after seven years. While this interest rate spread changes with market conditions, Turbo mortgages benefit from cash flow savings (periodic payment differences) resulting from a positive interest rate spread in most markets by utilizing an interest-adjustment date often ranging between one and ten years.

Additionally, an eTurbo loan utilizes interest-only or interest-deferred payments to fund larger additional benefits. Funds that would have amortized the loan (the periodic payment difference between the standard loan and one or more interest-only or interest deferred loans) are invested in a choice of stock market instruments such as index mutual funds or exchange-traded funds. So long as the average net annual total return from such investments equals or exceeds some minimum annual rate of return, the investment portfolio's value will always equal or exceed the amortization of a standard loan. That is, the proceeds of eTurbo's scheduled periodic investment installments will be sufficient to repay the interest-only or interest-deferred loans at a rate equal to, or greater than, the scheduled rate of repayment of the standard loan. In other words, the effective unpaid principal balance of an eTurbo loan (original loan balance less Investment portfolio value) will always be equal to, or less than, the unpaid principal balance of a standard loan. To assure this result, an eTurbo loan may incorporate insurance guaranteeing that minimum rate of return (an amortization guarantee).

Turbo loans are designed to use the cash flow benefits of an interest rate yield curve, and of the interest-only feature of an eTurbo loan, to provide borrowers with additional borrower benefits unavailable from standard loans (beyond those available from a standard loan and other than periodic payment savings). The trade-off a Turbo borrower accepts for these additional benefits is an interest rate adjustment that often occurs after one to ten years.

### AN EXAMPLE

An example illustrates the versatility of Turbo loans. For briefness and clarity of exposition, the example contains a variety of assumptions, but in fact, the benefits of Turbo loans are relatively insensitive to underlying assumptions.

Assume that Bob and Mary Smith have received a quote for a standard 30-year, fixed-rate, fully-amortizing mortgage loan (defined earlier as the standard loan) of $100,000 and want to compare that loan with Turbo alternatives. Table A in FIG. 2 summarizes the comparison.

In this example, a standard loan has a fixed, annual interest rate of 7.50% and requires a monthly payment of principal and interest of $699.21. It fully amortizes over 30 years and has a remaining unpaid principal balance of $91,834 at the end of seven years. If Bob and Mary choose this alternative, they would reduce their mortgage's unpaid principal balance by $8,166 over seven years.

A seven-year interest-adjustment date results in a lower interest rate for a Turbo loan. In this example, the interest rate differential between 7- and 30-year loans is 37.5 basis points. If this entire differential were passed on to Bob and Mary, they would pay 7.125% on their loan However, Turbo loans are also designed to allow mortgage originators the option to increase their profitability by retaining some portion of the differential. In the example, the originator retains 15% of the differential, and Bob and Mary pay 7.181% on aTurbo mortgage.

eTurbo allows Bob and Mary to invest in the stock market with dollars that would otherwise be required to amortize their mortgage. Their monthly payment amount is exactly the same as a standard loan, but the mortgage is serviced with interest-only payments at a 7.181% interest rate. The remainder of their monthly payment is invested in the stock market on a dollar-cost-averaging basis. So long as such stock market investments yield a net average annual total rate of return greater than a negative 1.05%, the value of their stock portfolio will always equal or exceed the amortization of a standard loan during the seven-year period. If their portfolio were to achieve a net average annual total rate of return of 10.5%, its value after seven years will amount to $12,425, at which point the couple's home equity will be 52% greater than if they had chosen a standard loan. Furthermore, they will not pay more in mortgage payments nor incur additional debt.

pTurbo allows Bob and Mary to pay off their mortgage more rapidly than a standard loan. Since the total monthly payment on a 7.181% pTurbo loan is the same as that required on a 7.50% standard loan, the additional principal component causes the pTurbo loan to fully amortize over 27 years and to have a remaining unpaid principal balance of $88,993 after seven years. If Bob and Mary choose this alternative, they will reduce their mortgage by $11,007, and their accumulated equity after seven years will be 35% greater than that of a standard loan. Again, they will not pay more in mortgage payments nor incur additional debt.

iTurbo protects Bob and Mary with term life insurance. Their mortgage payment amount is exactly the same as a standard loan, but the mortgage is serviced with principal and interest payments at a 7.181% interest rate. The difference between this payment and that of a standard loan funds monthly premiums on term life insurance policies on Bob and/or Mary's life. The amount of insurance is a function of insurance premiums, which in turn reflect the insureds' ages, genders and perhaps other factors.

In the example, total insurance coverage amounts to $214,000, but it will vary depending on the age and other personal characteristics of the borrower(s). However, since iturbo tends to be more attractive to young couples with larger family commitments relative to their assets, most iTurbo borrowers should be able to at least pay off their mortgage in the event of the death of one of the borrowers In terms of equity accumulation, iTurbo amortizes slightly faster than a standard loan. Yet again, Bob and Mary do not pay more in mortgage payments and do not incur additional debt.

Bob and Mary discover that a Turbo loan offers them important advantages over a standard mortgage, provided they are willing to accept an interest adjustment that often occurs after one to ten years. Their choice among pTurbo, eTurbo or Turbo is determined by their personal preferences and circumstances, as well as by the tradeoffs between and among the loans. But in all cases, Bob and Mary make exactly the same monthly payment as with a standard loan, do not incur additional debt, and gain important additional benefits.

### THE PRESENT INVENTION AND DESCRIPTION OF PRIOR ART

The eTurbo Mortgage

The eTurbo loan offers the greatest potential for gain relative to a standard loan, but also slightly greater risk. However, the risk can be mitigated for the borrower and/or the lender/investor by purchasing insurance guaranteeing a minimum rate of return on eTurbo's investments (an amortization guarantee). In the example set forth in Table A of FIG. 2, eTurbo's investment portfolio will always equal or exceed the amortization of a standard loan so long as such minimum net average annual total return is not worse than a negative 1.05% over seven years.

At the same time, eTurbo allows Bob and Mary to reduce their overall risk, and potentially improve their rate of return, by diversifying their assets. Rather than concentrating their assets in their home, eTurbo allows them to also build a stock portfolio on a dollar-cost-averaging basis. Depending on local real estate conditions, this diversification can offer important financial advantages.

Moreover, to the extent that eTurbo's cumulative investment portfolio exceeds the principal reduction that would have occurred with a standard loan (a certainty if the portfolio's net average annual total rate of return exceeds its minimum required return), “excess” portfolio value will exist. Such incremental equity accumulation can be used in a variety of ways. As an example but not limitation, it may remain invested after paying off the current mortgage or be “rolled over” to a new mortgage. Unlike the prescribed equity of a standard loan (amortization of the original loan amount), eTurbo's excess investment portfolio, continuously invested, will likely grow to more than twice the total equity of a standard borrower over a 30 year period.

In the U.S. today, an inadequate number of consumers save for their retirement or educational needs. Those who do are typically not saving enough. eTurbo mortgage represents a disciplined, available-to-all, installment investment plan that enables individuals to provide for their future years and needs. It does so with the optional security of an amortization guarantee, the potential for high equity rates of return, and without the need to incur additional debt or further burden their cash flow by allocating additional funds for investment purposes.

For eturbo borrowers who achieve excess value in their investment portfolios, a significant incentive to stay invested and remain with their current mortgage lender/servicer may exist. Retention of current customers who might otherwise move to other lenders is currently a major goal of the mortgage industry.

To some, the eTurbo mortgage might resemble the endowment mortgage extant in the U. K. and Ireland, but it is different. Endowment mortgage borrowers make two monthly payments (versus one for eTurbo borrowers): a variable interest payment paid in advance (whose interest rate the lender can arbitrarily change at any time, in contrast to eTurbo's fixed payment of interest in arrears), and a fixed premium payment on a life assurance or endowment policy (a combination life insurance and savings policy). The face amount of the endowment policy is typically greater than the original mortgage. Endowment premiums are invested in the security markets, and the mortgage is not repaid prior to maturity. However, at loan maturity, when the assurance policy “should” provide investment proceeds to payoff the mortgage, its value is not guaranteed. Predictably, unfavorable investment results have forced many borrowers to unhappily increase monthly payments, extend the maturity date, or default.

While U.S. mortgage markets are quite different from the U. K. and Irish markets, efforts to utilize investment returns (directly or indirectly in the stock market) as a source of repayments for home mortgages have been proposed. In general, these proposals do not favor lower-income borrowers. Nor have they satisfied a key mortgage underwriting requirement that determines eligibility for the lowest mortgage rates from institutional investors in the secondary mortgage market.

To obtain the lowest interest rates in the secondary mortgage market, the credit risk of a home mortgage must be “investment quality.” This imprimatur is only awarded to loans that fully comply with well-established and commonly followed underwriting guidelines of mortgage institutions. Historically, their primary credit risk concern was the probability of a decreased rate of home equity accumulation, and they therefore required a predictable, gradual reduction of debt (because borrowers can more easily bear small periodic burdens than a single, large, final obligation).

However, Fannie Mae (the largest of such institutions) recently expanded its guidelines to add interest-only loans to its product line. To compensate for increased credit risk, Fannie Mae assesses higher interest rates for interest-only loans than for amortizing loans with the same maturity. Thus, more favorable mortgage pricing mandates minimum, predictable repayment as provided by eTurbo (especially with an amortization guarantee).

U.S. Pat. No. 5,987,436 to Halbrook (1999) increases a borrower's costs and debt via a separate investment loan and assumes sufficient equity to justify additional debt. As such, it would not be suitable for lower-income borrowers with small down payments. Halbrook's patent assumes that the net rate of return on the investments made possible by leveraging available home equity will be greater than the investment loan's borrowing rate, but he provides no protection in the event it is not. The uncertainty concerning such an assumption, as well as the increased debt load, increases credit risk.

U.S. Pat. No. 4,876,648 to Lloyd (1989) incorporates a mortgage loan partially collateralized by a separate investment vehicle and seeks to protect lenders from the vagaries of interest rate swings; however, it does so by charging borrowers an additional interest rate over and above prevailing market rates (which increases the cash flow burden of the borrower). In contrast, eTurbo's investment account is primarily for the benefit of the borrower and the borrower's cash flow burden is not increased

U.S. Pat. No. 5,673,402 to Ryan (1997), roughly modeled after endowment mortgages, does not establish predictable rates of repayment; rather, uncertain investment results (hopefully) repay the mortgage. Consequently, it has the same critical repayment weakness as endowment mortgages.

U.S. Pat. Nos. 5,911,135 and 5,911,136 to Atkins (1999) utilize a technique of variable mortgage debt repayment and discretionary allocation of mortgage payments that preclude predictable, minimum periodic repayments. Also, the technique is not easily implemented by standard mortgage servicing systems and may occasion greater cash flow burdens on borrowers.

The foregoing and other problems of prior art are addressed by the present invention in its eTurbo embodiment.

The pTurbo Loan

pturbo offers a more conservative choice in the event borrowers are not confident of earning a sufficient rate of return in the stock market and do not need additional insurance coverage. By simply amortizing the mortgage more rapidly, pTurbo offers a significant benefit.

While there are many accelerated principal reduction schemes in the mortgage industry today, virtually all involve the payment of additional fees to the lender or third party administrator as well as additional mortgage payments. Most principal reduction efforts are on a month-to-month voluntary basis.

Unlike U.S. Pat. No. 6,269,347 to Berger (2001) which establishes rapid repayment of mortgage debt by dedicating 100% of the monthly payment to principal reduction until the loan is paid off (and makes the unlikely assumption the lender will not charge interest on the accrued, unpaid interest payments), the pTurbo loan pays both interest and principal on a periodic basis. Thus, pTurbo is more realistic and “lender-friendly,” and will not carry a higher interest rate due to interest deferral.

U.S. Pat. No. 5,878,404 to Stout, et al (1999) seeks to accelerate amortization when interest rates decline by granting a borrower the option (at additional cost) to lower his/her interest rate. pTurbo already incorporates a lower initial medium-term rate, and no additional cost is required.

U.S. Pat. No. 5,689,649 to Altman, et al (1997) creates an accelerated payment of principal by increasing the frequency of periodic payments (and thus the borrower's annual cash flow burden) and using the difference between accelerated and non-accelerated payments to justify an additional home equity loan, whose proceeds are invested in a separate investment vehicle. In contrast to pTurbo, a borrower has more debt to retire, and more frequent loan payments (with a greater cash flow burden)

The foregoing and other problems of prior art are addressed by the present invention in its pTurbo embodiment.

The iTurbo Loan

iTurbo offers the most conservative choice for young families who want protection against catastrophic loss. The loan pays down as quickly as a standard loan, but the periodic payment of fixed premiums offers the peace of mind of knowing that the mortgage is paid off in the event of death.

U.S. patents to Atkins (1999), referred to above, establish mortgages with discretionary payments of variable, non-capped insurance premiums for life insurance policies (the preferred investment vehicles), rely on the uncertain buildup of cash values on the underlying policies for future premium payments and debt retirement, and invest ownership of the policies in lenders, not borrowers.

U.S. patent to Ryan (1997), also referred to above, likewise combines insurance coverage with mortgage cash flow, but does so in a way that an insurance policy replaces the down payment, so that the full purchase price of the home is borrowed. Such an approach suffers from higher cash flow costs than the iTurbo mortgage and the critical repayment weakness of endowment mortgages described above.

The foregoing and other problems of prior art are addressed by the present invention in its iTurbo embodiment.

### OBJECTS AND ADVANTAGES

Expanding upon the features and benefits summarized above, several objects and advantages of the present invention comprise the following:

(a) To utilize the benefits of an interest rate yield curve to provide mortgage borrowers with additional benefits without increasing their cash flow costs or debt levels.

(b) To provide a loan whose predictable periodic payment and rate of debt repayment would match those of an alternative standard mortgage (eTurbo would require an amortization guarantee), thereby:

(1) enhancing prospects for favorable borrower qualification and interest rate pricing;

(2) providing borrowers with the security of predictable payments and debt amortization, as well as the potential of greater wealth;

(3) protecting mortgage investors' collateral values (if cross-collateralized); and

(4) avoiding moral risk (extending credit to borrowers whose loan balances do not decrease with periodic payments or who may not be able to make their periodic payments if interest rates increase) and the prospect of predatory lending allegations.

(c) To bundle common financial services in a unique manner so as to provide a mortgage borrower with methods of wealth building and/or preservation that are more convenient (one periodic payment), disciplined, consistent, economical (lower cost), and available (to the average person) than those otherwise available.

(d) To provide a loan with minimal additional documentation and loan servicing requirements, thereby minimizing alterations to standard mortgage industry procedures and costs.

(e) To provide mortgage lenders with an additional source of revenue in the form of the loan originator's participation in interest rate spread.

(f) To provide mortgage lenders, servicers, and investors with opportunities to improve their retention of customers.

(g) To provide fixed-rate mortgage lenders with additional means to compete against adjustable-rate lenders.

(h) To provide mortgage lenders, servicers and investors with potentially enhanced collateral values.

Additional unique objects and advantages of the eTurbo embodiment of the present invention comprise the following:

(i) To utilize interest-only or interest-deferred mortgages so as to maximize the periodic payment amounts available to provide mortgage borrowers with additional benefits without increasing borrowers' cash flow costs.

(j) To diversity a borrower's assets between real estate and stock investments, so as to optimize asset portfolio protection and/or appreciation over various, and likely differing, real estate and stock market cycles, while offering the benefits of investing on a dollar-cost-averaging basis.

(k) To provide an interest-only, non-amortizing loan to mortgage lenders, servicers and investors, thereby:

(1) providing incremental profitability via a non-declining revenue stream; and

(2) enabling mortgage investors to avoid reinvestment risk until repayment.

(l) To provide a mortgage that performs well for a borrower both during lower inflation (likely accelerating debt reduction) and during higher inflation, (when the value of real estate likely appreciates).

Still further objects and advantages of Turbo loans will become apparent from the ensuing description, drawing and tables.

### BRIEF DESCRIPTION OF THE DRAWING FIGURE AND TABLES

For a more comprehensive understanding of the present invention, reference is made to the following drawing and tables:

FIG. 1 sets forth a system summarizing the method and data processing apparatus of the present invention.

FIG. 2 sets forth Table A, which compares examples of Turbo alternatives to the standard loan.

FIG. 3 sets forth Table B, which summarizes the variables used in constructing and analyzing Turbo loans.

FIG. 4 sets forth Table C, which utilizes the variables in Table B to posit the preferred and/or alternative embodiments of a Turbo loan.

### OVERVIEW OF THE PREFERRED AND/OR ALTERNATIVE EMBODIMENTS

The present invention is best understood by referring to the drawing and the tables that are incorporated herein as follows:

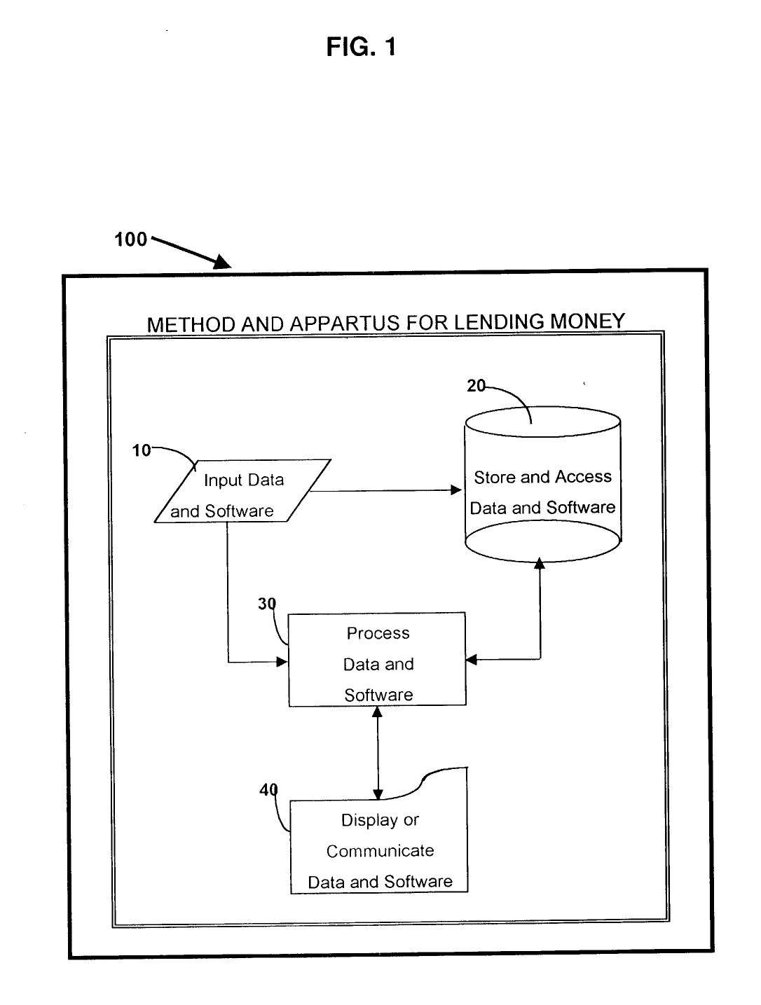

FIG. 1 sets forth a system 100 for inputting, storing, accessing, processing, displaying, and communicating data and software. A user may be a potential borrower, lender or investor. System 100 comprises a loan origination method and apparatus, preferably modifying existing computer systems and software.

Step 10 of FIG. 1 comprises one or more means for inputting data and software. By way of example and not limitation, the input device(s) to accomplish Step 10 may comprise a data processing keyboard, a device to read data from readable media, or a device to receive data from remote devices. Step 10 communicates with Steps 20 and 30.

Step 20 in FIG. 1 comprises one or more means for storing and accessing data and software. By way of example and not limitation, the device(s) to accomplish Step 20 may comprise a hard drive or magnetic tape device. Step 20 communicates with Step 30.

Step 30 in FIG. 1 comprises one or more means for processing data and software. By way of example and not limitation, the device(s) to accomplish Step 30 may comprise a computer processor that utilizes data and software from Steps 10 and 20. Step 30 calculates various monetary amounts and other data and communicates with Steps 20 and 40.

Step 40 in FIG. 1 comprises one or more means for displaying or communicating data and software. By way of example and not limitation, such means might comprise a computer printer or video display or one or more means of communication, such as a modem. Step 40 communicates with Step 30 and displays data from other steps in System 100 as appropriate.

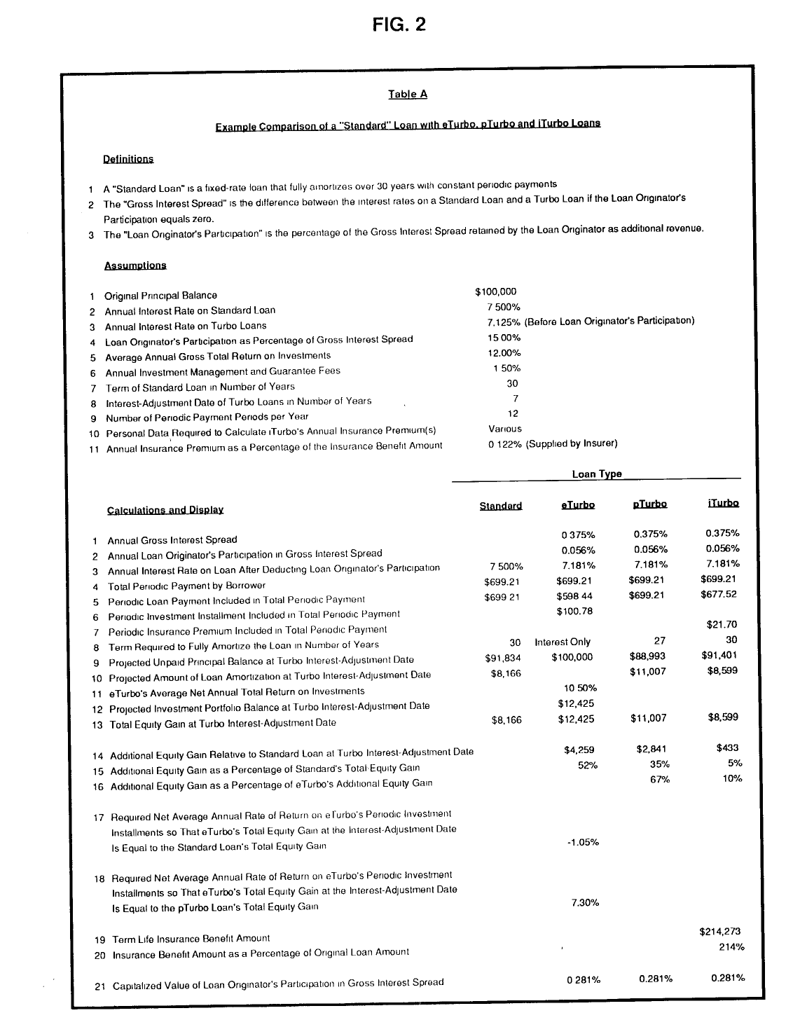

FIG. 2 sets forth Table A. Table A is an Example Comparison of a Standard Loan with eTurbo, pTurbo and iTurbo Loans. The comparison includes Definitions of variables that may not be obvious to one skilled in the art, Assumptions concerning variables that are obvious to one skilled in the art, Calculations that determine the various loans' features and benefits, and their resultant Display. Table A is more fully discussed in the foregoing Example section.

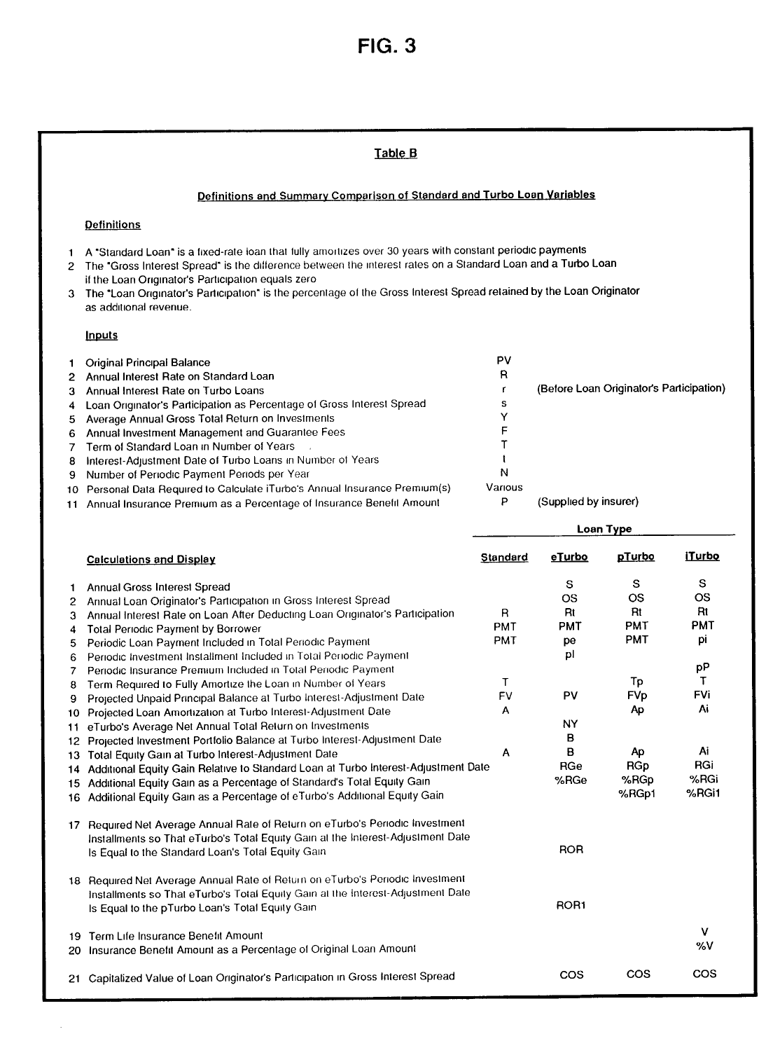

FIG. 3 sets forth Table B. Table B summarizes the variables used in constructing and analyzing Turbo loans.

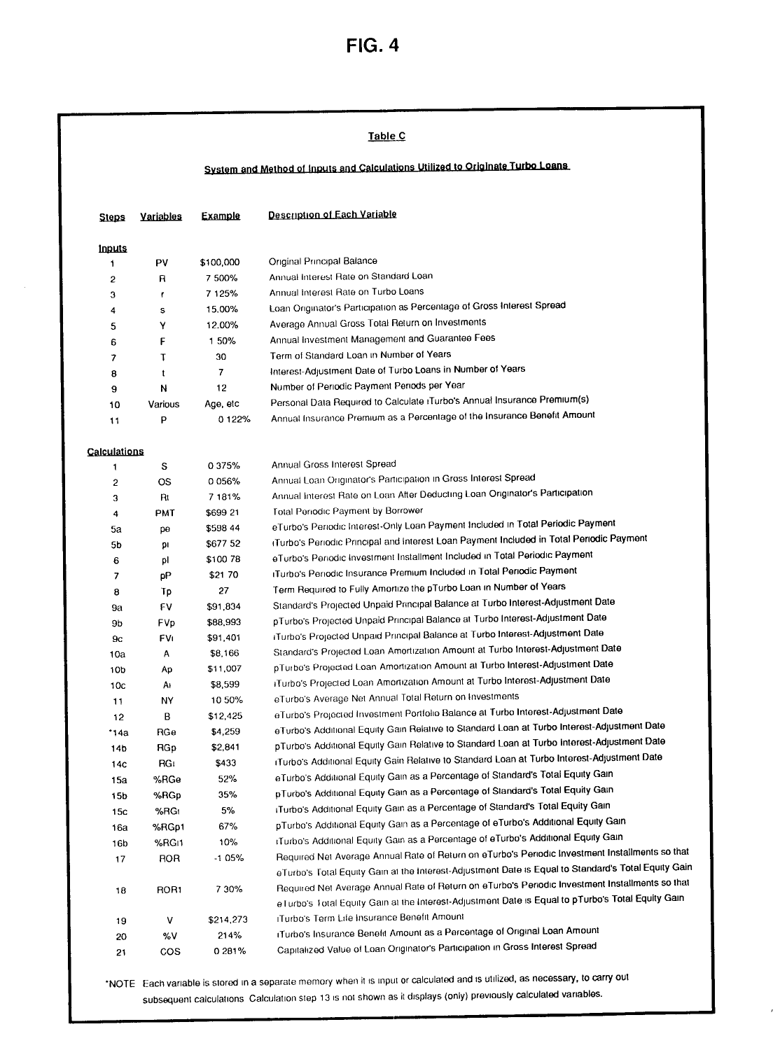

FIG. 4 sets forth Table C. Table C, using the variables summarized in Table B, sets forth the preferred and/or alternative embodiments of a Turbo loan, comprised of a system and method of inputs, calculations, and displays to originate such loans.

Thus, the preferred and/or alternative embodiments of the present invention as described above effect useful calculations and provide useful, concrete and tangible results. A more detailed description of the operation of these embodiments of the invention is provided below.

### DETAILED DESCRIPTION OF THE PREFERRED AND/OR ALTERNATIVE EMBODIMENTS

For clarity of exposition, items referred to either by number or symbol in the following description are identical to the items with the same numbers or symbols in Tables A, B and C (in FIGS. 2, 3, and 4, respectively). These tables provide additional perspective on the descriptions, components and interrelationships introduced in Table A's examples. As such, said tables are complementary constituents of the following narrative.

In the description below (and in the tables), it is assumed that the value of each variable is stored in separate memory when it is input or calculated, and is utilized as needed to carry out subsequent calculations of other variables.

It is also assumed that all periodic payments and investment installments are made timely.

The descriptions below (and the tables) further assume that the rate of return on investments for the eTurbo loan is deterministic. In reality, it is a random stochastic variable. However, no significant difference exists between the average rates of return calculated in either manner. This is also true for eTurbo's annual management and guarantee fees. Finally, the term “equity gain,” as used below, while having the same general meaning for all Turbo loans, is defined differently for the eTurbo loan than for iTurbo and pTurbo loans. For eTurbo, said term means the value of its investment portfolio at the interest-adjustment date. For the others, said term means the reductions in their respective unpaid principal balances at the interest-adjustment date.

A user of the present invention would first obtain and then input the data listed immediately below. Subsequently, the user would proceed to perform the calculations and/or display sequenced thereafter.

In the input, calculations and/or display, the sequence of each basic input and calculation/display is given by a number. Where such calculation/display applies uniquely to one specific loan, a lower case letter follows the number.

### INPUT

1 The original principal balance (PV) of the loan.

2 The annual interest rate (R) that would be charged on the standard loan used for comparison.

3 The annual interest rate (r) on a Turbo loan before a loan originator's participation.

4 The loan originator's participation in the gross interest spread (s) as a percentage of the gross interest spread.

5 The eTurbo loan's assumed gross average annual total return on investments (including dividend reinvestments) as a percentage of invested assets (Y)

6 The eTurbo loan's projected average annual investment management and guarantee fees as a percentage of invested assets (F).

7 The term or number of years for the full amortization of the standard loan used for comparison, assuming fixed periodic payments of principal and interest (T).

8 The number of years until the interest-adjustment date of Turbo loans (t).

9 The number of payment periods (N) in a year

10 Personal data required to calculate iTurbo's annual term life insurance premium(s) for a borrower(s).

11. iTurbo's annual term life insurance premium(s) for the borrower(s) (P), as a percentage of the insurance benefit amount.

### CALCULATE AND/OR DISPLAY

1 The annual gross interest spread for Turbo loans (S) before deducting the loan originator's participation. Algebraically, S=R−r.

2 The loan originator's participation in the gross interest spread (OS). Algebraically, OS=S×s.

3 The interest rate on Turbo loans (Rt) after deducting the loan originator's participation in the gross interest spread. Algebraically, Rt=r+OS

4 The total periodic payment to be made by a borrower (PMT) by calculating the periodic payment of principal and interest on the standard loan used for comparison utilizing variables PV, R, T and N.

5a eTurbo's periodic interest-only loan payment (pe) included in the total periodic payment. Algebraically, pe=(PV×Rt)÷N

5b iTurbo's periodic principal and interest loan payment (pi) included in the total periodic payment by utilizing variables PV, Rt, T and N.

6 eTurbo's periodic investment installment (pl) included in the total periodic payment. Algebraically, pl=MT−pe. Viewed differently, pl also equals the sum of two periodic payment differences. The first periodic payment difference is the remainder of PMT minus pl. The second periodic payment difference is the remainder of pi minus pe. Thus, this variable can also be expressed algebraically as:

pl=(PMT−pi)+(pi−pe).

7 iTurbo's periodic insurance premium (pP) included in the total periodic payment. Algebraically, pP=PMT−pi. Also, pP equals the first periodic payment difference defined previously.

8 The term or number of years required to fully amortize pTurbo (Tp) by utilizing variables PV, PMT, Rt and N.

9a The projected unpaid principal balance (FV) of the standard loan used for comparison at the interest-adjustment date for Turbo loans by utilizing variables PV, PMT, R, t and N.

9b pTurbo's projected unpaid principal balance (FVp) at the interest-adjustment date for Turbo loans by utilizing variables PV, PMT, Rt, t, and N

9c iturbo's projected unpaid principal balance (FVi) at the interest-adjustment date for Turbo loans by utilizing variables PV, pi, Rt, t and N.

10a The projected amount of amortization for the standard loan (A) used for comparison at the interest-adjustment date for Turbo loans. Algebraically, A=PV−FV.

10b pTurbo's projected amount of amortization (Ap) at the interest-adjustment date for Turbo loans. Algebraically, Ap=PV−FVp.

10c iTurbo's projected amount of amortization (Ai) at the interest-adjustment date for Turbo loans. Algebraically, Ai=PV−FVi.

11 eTurbo's average net annual total return on investments (NY) as a percentage of invested assets. Algebraically, NY=Y−F.

12 eTurbo's projected investment portfolio value (B) at the interest-adjustment date for Turbo loans by utilizing variables pl, NY, t and N.

13 [Display (only) previously calculated variables A, B, Ap, and Ai to emphasize to the user that these variables are also equivalent to standard's, eturbo's, pturbo's, and iTurbo's “total equity gain,” respectively, at the Turbo interest-adjustment date.]

14a eTurbo's additional equity, which equals the amount by which eTurbo's projected investment portfolio value exceeds the projected amortization amount of the standard loan used for comparison at the interest-adjustment date for Turbo loans (RGe). Algebraically, RGe=B−A.

14b pTurbo's additional equity, which equals the amount by which pTurbo's projected amortization amount exceeds that of the standard loan used for comparison at the interest-adjustment date for Turbo loans (RGp). Algebraically, RGp=Ap−A.

14c iTurbo's additional equity, which equals the amount by which iTurbo's projected amortization amount exceeds that of the standard loan used for comparison at the interest-adjustment date for Turbo loans (RGi). Algebraically, RGi=Ai−A.

15a The percentage by which eturbo's additional equity exceeds the standard loan's projected amortization amount at the interest-adjustment date for Turbo loans (%RGe). Algebraically, %RGe=RGe÷A.

15b The percentage by which pturbo's additional equity exceeds the standard loan's projected amortization amount at the interest-adjustment date for Turbo loans (%RGp). Algebraically, %RGp=RGp÷A.

15c The percentage by which iTurbo's additional equity exceeds the standard loan's projected amortization amount at the interest-adjustment date for Turbo loans (%RGi). Algebraically, %RGi=RGi÷A.

16a The percentage relationship between pturbo's additional equity relative to eTurbo's at the interest-adjustment date for Turbo loans (%RGp1). Algebraically, %RGp1=RGp÷RGe.

16b The percentage relationship between iTurbo's additional equity relative to eTurbo's at the interest-adjustment date for Turbo loans (%RGi1). Algebraically, %RGi1=RGi+RGe.

17 The net average annual rate of return required on eturbo's periodic investment installments so that eTurbo's projected investment portfolio value at the interest-adjustment date for Turbo loans is equal to the projected amortization amount of the standard loan used for comparison (ROR) by utilizing variables N, t, pl and A.

18 The net average annual rate of return required on eTurbo's periodic investment installments so that eTurbo's projected investment portfolio value at the interest-adjustment date for Turbo loans is equal to the projected amortization amount of pturbo (ROR1) by utilizing variables N, t, pl and Ap.

19 iTurbo's term life insurance benefit amount for a borrower (V). Algebraically, V=(pP×N)÷P.

20 iTurbo's term life insurance benefit amount for a borrower as a percentage of iTurbo's original principal balance (%V). Algebraically, %V=V−PV

21 The capitalized value of the loan originator's participation in the gross interest spread in basis points (COS) by utilizing OS and a formula specified by each originator. Algebraically in the example, COS=OS×5.

### ADDITIONAL EMBODIMENTS

Nothing herein should be construed to limit the present invention. In addition to the embodiments set forth herein and in the tables, a number of other embodiments may exist by which to originate a Turbo loan. All such embodiments would have in common (be essentially equivalent to) the present invention's basic method of utilizing the benefits of an interest rate yield curve to provide borrowers with additional benefits while not increasing borrower cash flow costs or debt levels relative to a standard loan. Consequently, all such embodiments are incorporated herein by reference.

While Turbo loans herein have included eturbo, pTurbo, and iTurbo, other variations on the basic Turbo method (set forth in the previous paragraph) are possible and include, but are not limited to, the provision of borrower benefits utilizing other deposit, insurance, or investment vehicles, as well as other financial or non-financial benefits. All such variations are incorporated herein by reference.

The examples and descriptions herein include a variety of assumed and input values for purposes of example and not limitation. Nothing should be construed to limit the present invention to those assumed and input values.

The present invention has been described herein as a mortgage loan, but alternative embodiments might be non-mortgage loans and might utilize collateral other than real estate as security (or even be unsecured). For example (but not limitation), the present invention could be an asset-backed loan. All such variations are incorporated herein by reference.

While the examples and descriptions herein have been fixed-rate and fixed-payment loans, a Turbo loan could feature a variety of fixed, variable or adjustable interest rates and/or payments, payment deferrals, and/or permanent or temporary interest rate buy-downs. All such variations are incorporated herein by reference.

While the examples and descriptions herein have envisioned eturbo investments being made in mutual funds, they might be invested in other deposit, insurance, or investment vehicles. All such variations are incorporated herein by reference.

Guaranteed rates of return (amortization guarantees) on eTurbo investments can provide protection to the lender, investor, and/or borrower. Guarantees could be issued by mortgage institutions or purchased from third party insurers. In the final analysis, the extent to which amortization is guaranteed will be a function of what lenders and investors require, what borrowers prefer, and what insurers will guarantee. Such amortization guarantees could be different as between the borrower, mortgage investor, and lender. All such variations are incorporated herein by reference.

Collateralization is another issue for the market to decide. If lenders/investors prefer to collateralize their eTurbo loans (in whole or in part) with the resulting investment, insurance, or deposit accounts, the present invention makes provision for such a preference. In fact, borrowers may even prefer cross-collateralization if it results in lower interest rates. All such variations are incorporated herein by reference.

Formats and variables may exist, beyond those shown in Tables A through C (in FIGS. 2-4) herein, by which to originate a Turbo loan. All such formats and variables are incorporated herein by reference.

While each Turbo loan presented above has been structured as one loan, any grouping of loans, periodic payments, investments, deposits, and/or insurance structured so as to be essentially equivalent to the present invention is incorporated herein by reference.

While the examples and descriptions herein have specified an interest-adjustment date, a Turbo loan could be structured with a maturity date instead. The time period that such dates might encompass could be lesser or greater than the time periods discussed and illustrated herein. All such variations are incorporated herein by reference.

A variety of options exist when Turbo's interest rate is adjusted. By way of example and not limitation, the loan could continue to function as before with changes only to the rate of interest and periodic payment, or the loan could be converted to a standard loan with a remaining term equal to the term of the standard loan less the initial term to the adjustment date. All such options and variations are incorporated herein by reference.

A variety of features that would extend the present invention's interest-adjustment date could be utilized, including (but not limited to) automatic renewals, rollovers, portability of the Turbo mortgage or its portfolio to other collateral, and so forth. All such features and variations are incorporated herein by reference.

In many cases, the order of the inputs, calculations and displays described herein could change without affecting the essence of the present invention. All such variations are incorporated herein by reference.

While the loan originator's participation in the interest spread has been expressed herein as a percentage of the total interest spread, it could be expressed instead as a fixed number of basis points or in dollars or some other measurement. All such variations are incorporated herein by reference.

While iTurbo's insurance premiums have been expressed herein as a percentage of the insurance benefit amount, they could be expressed instead in dollars or some other means. All such variations are incorporated herein by reference.

A Turbo loan may be structured with longer or shorter interest-adjustment periods than those described and illustrated herein. All such variations are incorporated herein by reference.

A loan with characteristics other than the standard loan described herein could serve as the standard loan in Tables A through C of FIGS. 2-4. All such variations are incorporated herein by reference.

A Turbo loan may be structured using the parameters of an arbitrary standard loan or without reference to a standard loan. All such variations are incorporated herein by reference

The payment frequency and/or cash flow of eturbo investment installments, insurance premiums, or deposits could be altered in a number of ways. The funds in the investment, insurance, or deposit account may be drawn down in whole or in part and/or augmented by a borrower, transferred to another purpose, investment, insurance, or deposit vehicle, or used for other purposes, and so forth All such variations are incorporated herein by reference.

### OPERATION

The present invention is compatible with common loan origination practices well known in the art. A user may utilize common procedures for qualifying a buyer (or extant mortgagor) and appraising the collateral property. A user may process, underwrite and fund the present invention so as to fully comply with standard mortgage underwriting guidelines.

The present invention is also compatible with common loan administration (or servicing) practices well known in the art.

The present invention can be implemented by modifying existing computer systems, software programs and administrative policies so as to avoid substantial incremental costs.

### CONCLUSION, RAMIFICATIONS, AND SCOPE

Accordingly, the present invention addresses and resolves many of the problems of prior art and current mortgage industry practices. It offers mortgage borrowers additional benefits without additional debt, cash flow burden, or risk of reduced debt amortization (eTurbo would require an amortization guarantee) while remaining relatively easy for mortgage lenders, servicers, and investors to implement. By way of example and not limitation, the present invention:

(a) Utilizes the benefits of an interest rate yield curve to provide mortgage borrowers with additional benefits without increasing their cash flow costs or debt levels.

(b) Provides a loan whose predictable periodic payment and rate of debt repayment would match those of an alternative standard mortgage (eTurbo would require an amortization guarantee), thereby:

(1) enhancing prospects for favorable borrower qualification and interest rate pricing;

(2) providing borrowers with the security of predictable payments and debt amortization, as well as the potential of greater wealth;

(3) protecting mortgage investors' collateral values (if cross-collateralized); and

(4) avoiding moral risk (extending credit to borrowers whose loan balances do not decrease with periodic payments or who may not be able to make their periodic payments if interest rates increase) and the prospect of predatory lending allegations.

(c) Bundles common financial services in a unique manner so as to provide a mortgage borrower with methods of wealth building and/or preservation that are more convenient (one periodic payment), disciplined, consistent, economical (lower cost), and available (to the average person) than those otherwise available.

(d) Provides a loan with minimal additional documentation and loan servicing requirements, thereby minimizing alterations to standard mortgage industry procedures and costs

(e) Provides mortgage lenders with an additional source of revenue in the form of the loan originator's participation in interest rate spread.

(f) Provides mortgage lenders, servicers and investors with opportunities to improve their retention of customers.

(g) Provides fixed-rate mortgage lenders with additional means to compete against adjustable-rate lenders.

(h) Provides mortgage lenders, servicers and investors with potentially enhanced collateral values.

Additionally, the eturbo embodiment of the present invention:

(i) Utilizes interest-only or interest-deferred mortgages so as to maximize the periodic payment amounts available to provide mortgage borrowers with additional benefits without increasing borrowers' cash flow costs.

(j) Diversifies a borrower's assets between real estate and stock, insurance or deposit investments, so as to optimize asset portfolio protection and/or appreciation over various, and likely differing, real estate and financial market cycles, while offering the benefits of investing on a dollar-cost-averaging basis.

(k) Provides an interest-only, non-amortizing loan to mortgage lenders, servicers and investors, thereby:

(1) providing incremental profitability via a non-declining revenue stream; and

(2) enabling mortgage investors to avoid reinvestment risk until repayment.

(l) Provides a mortgage that performs well for a borrower both during lower inflation (likely accelerating debt reduction) and during higher inflation, (when the value of real estate likely appreciates).

Nothing herein should be construed to limit the present invention. In addition to the embodiments set forth herein and in the tables, a number of other embodiments may exist by which to originate a Turbo loan. All such embodiments would have in common (be essentially equivalent to) the present invention's basic method of utilizing the benefits of an interest rate yield curve to provide borrowers with additional benefits while not increasing borrower cash flow costs or debt levels relative to a standard loan Consequently, all such embodiments are incorporated herein by reference.

While Turbo loans herein have included eturbo, pturbo, and iturbo, other variations on the basic Turbo method (set forth in the previous paragraph) are possible and include, but are not limited to, the provision of borrower benefits utilizing other deposit, insurance or investment vehicles, as well as other financial or non-financial benefits. All such variations are incorporated herein by reference.

The examples and descriptions herein include a variety of assumed and input values for purposes of example and not limitation. Nothing should be construed to limit the present invention to those assumed and input values.

The present invention has been described herein as a mortgage loan, but alternative embodiments might be non-mortgage loans and might utilize collateral other than real estate as security (or even be unsecured). For example (but not limitation), the present invention could be an asset-backed loan. All such variations are incorporated herein by reference.

While the examples and descriptions herein have been fixed-rate and fixed-payment loans, a Turbo loan could feature a variety of fixed, variable or adjustable interest rates and/or payments, payment deferrals, and/or permanent or temporary interest rate buy-downs. All such variations are incorporated herein by reference.

While the examples and descriptions herein have envisioned eTurbo investments being made in mutual funds, they might be invested in other deposit, insurance, or investment vehicles. All such variations are incorporated herein by reference.

Guaranteed rates of return (amortization guarantees) on eTurbo investments can provide protection to the lender, investor, and/or borrower. Guarantees could be issued by mortgage institutions or purchased from third party insurers. In the final analysis, the extent to which amortization is guaranteed will be a function of what lenders and investors require, what borrowers prefer, and what insurers will guarantee. Such amortization guarantees could be different as between the borrower, mortgage investor, and lender. All such variations are incorporated herein by reference.

Cross-collateralization is another issue for the market to decide. If lenders/investors prefer to additionally collateralize their eTurbo loans with the resulting investment, insurance, or deposit accounts, the present invention makes provision for such a preference. In fact, borrowers may even prefer cross-collateralization if it results in lower interest rates. All such variations are incorporated herein by reference.

Formats and variables may exist, beyond those shown in Tables A through C (in FIGS. 2-4) herein, by which to originate a Turbo loan. All such formats and variables are incorporated herein by reference.

While each Turbo loan presented above has been structured as one loan, any grouping of loans, periodic payments, investments, deposits, and/or insurance structured so as to be essentially equivalent to the present invention is incorporated herein by reference.

While the examples and descriptions herein have specified an interest-adjustment date, a Turbo loan could be structured with a maturity date instead. The time period that such dates might encompass could be lesser or greater than the time periods discussed and illustrated herein All such variations are incorporated herein by reference.

A variety of options exist when Turbo's interest rate is adjusted. By way of example and not limitation, the loan could continue to function as before with changes only to the rate of interest and periodic payment, or the loan could be converted to a standard loan with a remaining term equal to the term of the standard loan less the initial term to the adjustment date. All such options and variations are incorporated herein by reference.

A variety of features that would extend the present invention's interest-adjustment date could be utilized, including (but not limited to) automatic renewals, rollovers, portability of the Turbo mortgage or its portfolio to other collateral, and so forth. All such features and variations are incorporated herein by reference.

In many cases, the order of the inputs, calculations and displays described herein could change without affecting the essence of the present invention. All such variations are incorporated herein by reference.

While the loan originator's participation in the interest spread has been expressed herein as a percentage of the total interest spread, it could be expressed instead as a fixed number of basis points or in dollars or some other measurement. All such variations are incorporated herein by reference.

While iTurbo's insurance premiums have been expressed herein as a percentage of the insurance benefit amount, they could be expressed instead in dollars or some other means. All such variations are incorporated herein by reference.

A Turbo loan may be structured with longer or shorter interest-adjustment periods than those described and illustrated herein. All such variations are incorporated herein by reference.

A loan with characteristics other than the standard loan described herein could serve as the standard loan in Tables A through C of FIGS. 2-4. All such variations are incorporated herein by reference.

A Turbo loan may be structured using the parameters of an arbitrary standard loan or without reference to a standard loan. All such variations are incorporated herein by reference.

The payment frequency and/or cash flow of eTurbo investments, insurance premiums, or deposits could be altered in a number of ways. The funds in the investment, insurance, or deposit account may be drawn down in whole or in part and/or augmented by a borrower, transferred to another purpose, investment, insurance, or deposit vehicle, or used for other purposes, and so forth. All such variations are incorporated herein by reference.

Thus the scope of the present invention should be determined not by the embodiments and examples discussed and illustrated herein, but by the appended claims and their legal equivalents

We claim:

1) A method for lending money, utilizing the benefits of an interest rate yield curve and comprising means for:
(a) originating one or more loans, at least one of which carries an interest rate equal to, or lower than, the then-prevailing interest rate on an alternative, standard loan used for comparison;
(b) supplying one or more borrower benefits paid for, in whole or in part, by cash flow savings created by a first periodic payment difference between said one or more loans and the standard loan; and
whereby borrowers receive additional benefits, beyond those available from the standard loan and other than periodic payment savings, while incurring no cash flow costs or debt levels in excess of those of the standard loan.

2) The method of claim 1, wherein the method comprises means for implementing the method on a data processing apparatus.

3) The method of claim 1, wherein the method comprises means for originating mortgage loans.

4) The method of claim 1, wherein the method comprises means for providing borrowers with a rate of debt repayment greater than the scheduled rate of repayment of the standard loan.

5) The method of claim 1, wherein the method comprises means for providing borrowers with one or more insurance policies.

6) The method of claim 1, further including means for providing borrowers with an opportunity to receive larger additional benefits paid for, in whole or in part, by a second periodic payment difference between the standard loan and one or more interest-only or interest-deferred loans.

7) The method of claim 6, wherein the method comprises means for providing borrowers with investments, insurance or deposits

8) The method of claim 7, wherein the method comprises means for collateralizing a loan with the portfolio value of said investments, insurance or deposits.

9) The method of claim 7, further including means for creating one or more amortization guarantees assuring that proceeds of scheduled periodic investment installments, insurance premiums or deposits will be sufficient to repay said interest-only or interest-deferred loans at a rate equal to, or greater than, the scheduled rate of repayment of the standard loan.

10) A data processing apparatus for lending money, utilizing the benefits of an interest rate yield curve and comprising means for:
(a) inputting data and software;
(b) storing and accessing data and software;
(c) processing data and software;
(d) displaying or communicating data and software;
whereby said apparatus provides means for:
(e) originating one or more loans, at least one of which carries an interest rate equal to, or lower than, the then-prevailing interest rate on an alternative, standard loan used for comparison;
(f) supplying one or more borrower benefits paid for, in whole or in part, by cash flow savings created by a first periodic payment difference between said one or more loans and the standard loan; and
whereby borrowers receive additional benefits, beyond those available from the standard loan and other than periodic payment savings, while incurring no cash flow costs or debt levels in excess of those of the standard loan.

11) The data processing apparatus of claim 10, wherein the apparatus comprises means for originating mortgage loans.

12) The data processing apparatus of claim 10, wherein the apparatus comprises means for providing borrowers with a rate of debt repayment greater than the scheduled rate of repayment of the standard loan.

13) The data processing apparatus of claim 10, wherein the apparatus comprises means for providing borrowers with one or more insurance policies.

14) The data processing apparatus of claim 10, further including means for providing borrowers with an opportunity to, receive larger additional benefits paid for, in whole or in part, by a second periodic payment difference between the standard loan and one or more interest-only or interest-deferred loans.

15) The data processing apparatus of claim 14, wherein the apparatus comprises means for providing borrowers with investments, insurance or deposits.

16) The data processing apparatus of claim 15, wherein the apparatus comprises means for collateralizing a loan with the portfolio value of said investments, insurance or deposits.

17) The data processing apparatus of claim 15, further including means for creating one or more amortization guarantees to assure that proceeds of scheduled periodic investment installments, insurance premiums or deposits will be sufficient to repay said interest-only or interest-deferred loans at a rate equal to, or greater than, the scheduled rate of repayment of the standard loan.

18) A method for lending money, utilizing the benefits of an interest rate yield curve and comprising one or more loans, at least one of which is interest-only or interest-deterred and at least one of which carries an interest rate equal to, or lower than, the then-prevailing interest rate on an alternative, standard loan used for comparison, and whereby borrowers have an opportunity to receive additional benefits, beyond those available from the standard loan and other than periodic payment savings, while incurring no cash flow costs or debt levels in excess of those of the standard loan.

19) The method of claim 18, wherein the method is implemented on a data processing apparatus.

20) The method of claim 18, wherein the method comprises one or more amortization guarantees assuring that proceeds of scheduled periodic investment installments, insurance premiums or deposits will be sufficient to repay said interest-only or interest-deferred loans at a rate equal to, or greater than, the scheduled rate of repayment of the standard loan
